(19) United States
(12) Patent Application Publication
(10) Pub. No.: US 2018/0372067 A1
(43) Pub. Date: Dec. 27, 2018

(54) WIND TURBINE ROTOR BLADE AND WIND TURBINE

(71) Applicant: Wobben Properties GmbH, Aurich (DE)

(72) Inventor: Alexander HOFFMANN, Emden (DE)

(21) Appl. No.: 15/776,731

(22) PCT Filed: Nov. 16, 2016
(86) PCT No.: PCT/EP2016/077789

§ 371 Date: May 16, 2018

(30) Foreign Application Priority Data
Nov. 20, 2015 (DE) 10 2015 120 113.5

(51) Int. Cl. F03D 1/06

(52) U.S. Cl. CPC F03D 1/0675; F03D 13/40

(57) ABSTRACT

A wind turbine rotor blade comprising a rotor blade root, a rotor blade tip, and at least two rotor blade parts which are secured to one another by means of at least one securing unit in a dividing plane. The securing unit has a cross pin in a first rotor blade part, a first clamping device in or on the cross pin, a steel cable which is guided through a hole in the second rotor blade part and a second clamping device with which a second end of the steel cable is clamped. A first end of the steel cable is clamped in the first clamping device on a blade outer side. The second clamping device is provided on a blade inner side.

### BACKGROUND

### Technical Field

The present invention relates to a wind turbine rotor blade and a wind turbine.

### Description of the Related Art

Rotor blades of modern wind turbines can sometimes be so long that it is no longer possible to transport the rotor blade in one piece. Thus, a rotor blade of a wind turbine can be configured to be multipart so that the separate parts are supplied separately to the site and are then assembled there.

In the priority-substantiating German patent application, the German Patent and Trademark Office searched the following documents: DE 10 2010 046 518 A1, DE 10 2010 046 519 A1, DE 10 2006 022 279 A1.

### BRIEF SUMMARY

Provided is a wind turbine rotor blade and a wind turbine which has an improved connection of the parts of a multipart wind turbine rotor blade.

Thus, a wind turbine rotor blade comprising a rotor blade root, a rotor blade tip and at least two rotor blade parts are provided which are secured to one another by means of at least one securing unit in a dividing plane. The securing unit has a cross pin in a first rotor blade part, a first clamping device in or on the cross pin, a steel cable which is guided through a hole in the second rotor blade part and a second clamping device with which a second end of the steel cable is clamped. A first end of the steel cable is clamped in the first clamping device on the blade outer side. The second clamping device is provided on the blade inner side.

According to one aspect of the present invention, the wind turbine rotor blade comprises a deflecting unit in the opening in the second rotor blade part. Thus, the deflection of the steel cable can be simplified. Furthermore the steel cable can be better protected by the deflecting unit.

According to a further aspect of the present invention, the securing unit has a tensioning bolt which is coupled in or on the cross pin and on the second clamping device.

The present invention also relates to a wind turbine having at least one wind turbine rotor blade described above.

The invention also relates to a method for assembling a wind turbine rotor blade, which comprises a rotor blade root, a rotor blade tip, a wall, a blade inner side, a blade outer side and at least one first and second rotor blade part which are secured to one another by means of at least one securing unit in a dividing plane. The securing unit has a cross pin in a first rotor blade part, a first clamping device in or on the cross pin, a steel cable which is guided through a hole in the second rotor part and a second clamping device by means of which the second end of the steel cable is clamped. A first end of the steel cable is clamped in the first clamping device on the blade outer side. The second clamping device is provided on the blade inner side.

Further configurations of the invention are the subject matter of the subclaims.

The invention relates to an idea of connecting two components (for example, GFP components, glass-fiber-reinforced plastic components or carbon-fiber-reinforced plastic components) of a rotor blade of a wind turbine so that it is possible to maintain the connection from the inside of the rotor blade. A securing unit is provided for connecting two components of a wind turbine rotor blade, which securing unit comprises a first clamping device, at least one steel cable and a second clamping device. A first end of a steel cable is provided in the first clamping device for example on a blade outer side. The first clamping device is secured on a first rotor blade part. The steel part is guided through an opening in the second rotor blade part and secured on the inner side by means of a second clamping device. Since the second clamping device is provided on the blade inner side, the connection can be maintained from inside.

### BRIEF DESCRIPTION OF THE SEVERAL VIEWS OF THE DRAWINGS

Advantages and exemplary embodiments of the invention are explained in detail hereinafter with reference to the drawings.

FIG. 1 shows a schematic view of a wind turbine according to the invention,

FIG. 2 shows a schematic view of a multipart wind turbine rotor blade according to the invention and

FIG. 3 shows a sectional view of a section of a wind turbine rotor blade according to a first exemplary embodiment of the invention.

### DETAILED DESCRIPTION

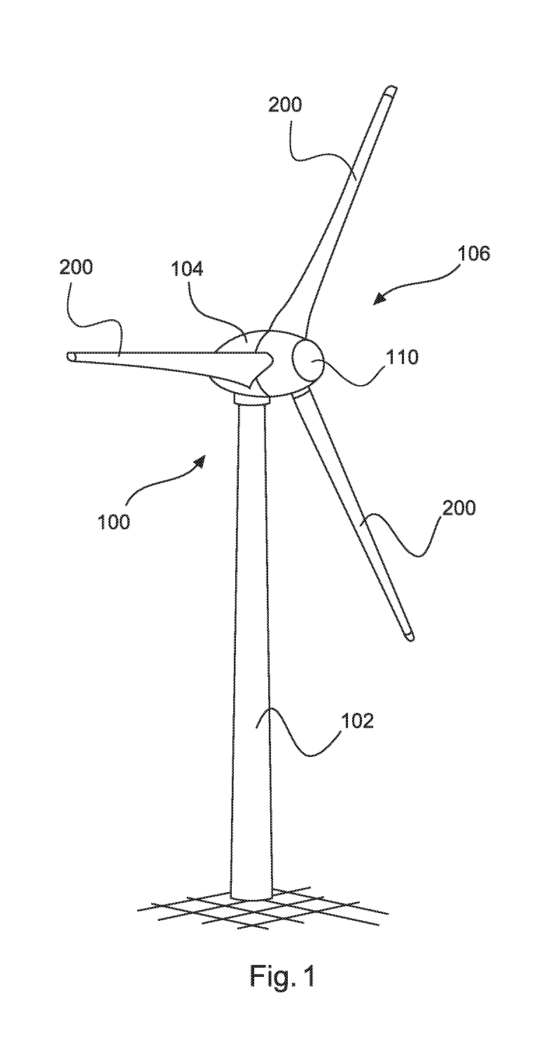

FIG. 1 shows a schematic view of a wind turbine according to the invention. The wind turbine 100 comprises a tower 102 and a nacelle 104 on the tower 102. An aerodynamic rotor 106 with three rotor blades 200 and a spinner 110 is provided on the nacelle 104. During operation of the wind turbine the aerodynamic rotor 106 is set into a rotary movement by the wind and thereby turns a rotor of a generator which is coupled directly or indirectly to the aerodynamic rotor 106. The electrical generator is arranged in the nacelle 104 and generates electrical energy. The pitch angle of the rotor blades 200 can be varied by pitch motors on the rotor blade roots of the respective rotor blades 200.

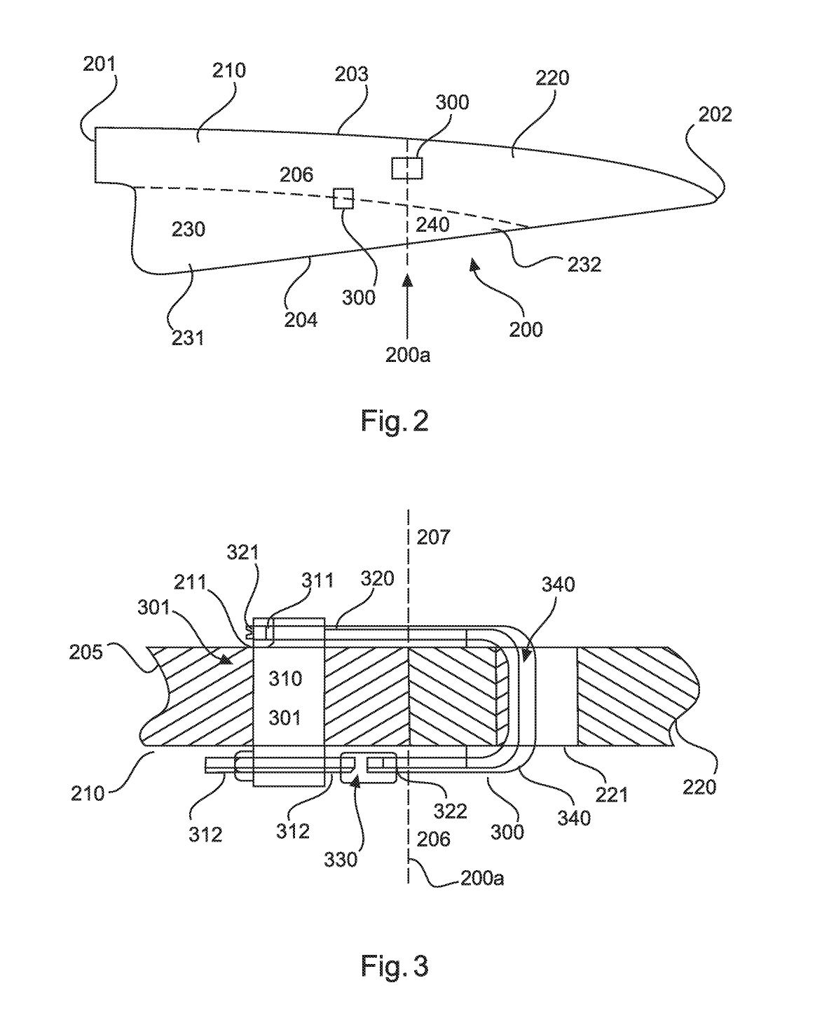

FIG. 2 shows a schematic diagram of a multipart wind turbine rotor blade according to the invention. The rotor blade has a rotor blade root 201, a rotor blade tip 202, a rotor blade front edge 203 and a rotor blade rear edge 204 and consists for example of three parts or sections 210-220. The rotor blade 200 has a dividing plane 200a. The rotor blade parts 210-220 can for example be secured to one another by means of securing units 300 and the dividing plane 200a. This section 230 can be configured to be divided into two parts 231, 232, wherein the first part 231 is secured to the first section 210 and the second part 232 is secured to the second section 220.

FIG. 3 shows a sectional view of a section of a wind turbine rotor blade according to a first exemplary embodiment of the invention. FIG. 3 shows a first rotor blade part 210, a second rotor blade part 220 and the securing unit 300. The first and second rotor blade part 210, 220 each have a wall 205, a blade inner side 206 and a blade outer side 207. In the first rotor blade part 210 a first clamping device 311 is provided in a cross pin 301. Thus, the rotor blade also has a blade inner side 206 and a blade outer side 207.

The securing unit 300 further comprises at least one steel cable 320, a second clamping device 330 and a tensioning bolt 312 with a nut and optionally a support with disk springs. A first end 321 of the steel cable 320 is clamped in the first clamping device 311 (which is provided on the blade outer side 207), then the steel cable 320 is guided on the blade outer side 207 and is guided through a hole 221 in the second rotor blade part 220 into the blade interior 206. The second end 322 is clamped in the second clamping device 330 (on the blade inner side 206). The second clamping device 330 is connected to the cross pin 301 via a tensioning bolt 312.

Since the second clamping device 330 is provided on the blade inner side 206, this clamping device can be maintained from inside out.

The steel cable 320 can be pre-bent at least in sections and in particular in the region where the steel cable is to be guided through the blade opening 221. The second clamping device 330 can be provided in a wedge-shaped, conical or trapezoidal groove in the bolt 312. Thus, the cable can secure itself by tensional stress.

Optionally a deflecting unit 340 can be provided in the region of the hole 221 of the second rotor blade part 220. The steel cable 320 can be guided in this deflecting unit 340 through the hole 221. The deflecting unit 340 can be provided for protection of the steel cable because this can prevent the steel cable 340 from being damaged at the edges of the opening 221. Furthermore, it can thus also be avoided that the edges of the opening 221 become damaged.

Alternatively to the steel cable 320, a material made of another material which has similar mechanical properties can also be used.

1. A wind turbine rotor blade, comprising:
a rotor blade root, a rotor blade tip, a wall, a blade inner side, a blade outer side and first and second rotor blade parts that are secured to one another by at least one securing unit at a dividing plane,
wherein the securing unit has a cross pin in a first rotor blade part, a first clamping device in or on the cross pin, a steel cable guided through a hole in the second rotor blade part, and a second clamping device, wherein a second end of the steel cable is clamped by the clamping device,
wherein a first end of the steel cable is clamped in the first clamping device at the blade outer side, and
wherein the second clamping device is provided at the blade inner side.

2. The wind turbine rotor blade according to claim 1, further comprising a deflecting unit in the opening in the second rotor blade part.

3. The wind turbine rotor blade according to claim 1, wherein the securing unit has a tensioning bolt coupled in or on the cross pin and on the second clamping device, wherein the tensioning bolt is configured to tension the steel cable.

4. The wind turbine rotor blade according to claim 1, wherein the dividing plane is between the rotor blade root and the rotor blade tip.

5. A wind turbine having at least one wind turbine rotor blade according to claim 1.

6. A method for assembling a wind turbine rotor blade, wherein the wind turbine rotor blade comprises a rotor blade root, a rotor blade tip, a wall, a blade inner side, a blade outer side and first and second rotor blade parts that are secured together by at least one securing unit in a dividing plane, wherein the at least one securing unit has a cross pin in a first rotor blade part, a first clamping device in or on the cross pin, a steel cable, and a second clamping device, the method comprising:
guiding the steel cable through a hole in the second rotor blade part,
clamping a second end of the steel cable in the second clamping device, and
clamping a first end of the steel cable in the first clamping device at the blade outer side,
wherein the second clamping device is provided at the blade inner side.
